(19) United States
(12) Patent Application Publication
(10) Pub. No.: US 2018/0074813 A1
(43) Pub. Date: Mar. 15, 2018

(54) INSTALLING VEHICLE UPDATES

(71) Applicant: General Motors LLC, Detroit, MI (US)

(72) Inventors: Shawn F. Granda, NOVI, MI (US); Jeffrey J. Olsen, ROYAL OAK, MI (US); Ganesh Srinivasan, NOVI, MI (US)

(21) Appl. No.: 15/265,657

(22) Filed: Sep. 14, 2016

(51) Int. Cl. G06F 9/445; H04L 29/08

(52) U.S. Cl. CPC G06F 8/67; H04L 67/34; H04L 67/12

(57) ABSTRACT

A communication system and a method of using the communication system to install a vehicle update in a vehicle system module (VSM) onboard a vehicle while enabling the vehicle to remain in a mobilized state during the installation of the vehicle update. The method includes the steps of receiving a vehicle update for a target VSM in the vehicle while the vehicle is in the mobilized state; performing a hand-off operation procedure between a proxy device and the target VSM so that the proxy device is granted permission to execute vehicle operating instructions as if the proxy device is the target VSM; thereafter, installing the vehicle update at the target VSM; and continuing operation of the vehicle in the mobilized state using the proxy device instead of the target VSM during the installing step.

### TECHNICAL FIELD

The present invention relates to installing vehicle updates, and more particularly, to installing vehicle updates while the vehicle is in a mobilized state.

### BACKGROUND

A vehicle user may take his/her vehicle to a vehicle manufacturer or service facility to install software and/or firmware updates to one or more electronic control units or other electronic devices in the vehicle. During such installations, the vehicle is immobilized or in an immobilized state. For example, the vehicle ignition may be required to be ‘off,’ the vehicle transmission may be required to be in PARK, etc. In the immobilized state, normal or typical vehicle operations are temporarily suspended—e.g., to avoid vehicle operation when in an undefined or unintended state. Thus, during software/firmware updates, the manufacturer or service technician immobilizes the vehicle so that it cannot be driven, removed from PARK, or the like. In this manner, the user cannot operate or drive the vehicle during such updates.

Thus, to improve the user experience, it would be desirable to provide a way to update instructions executed by vehicle electronics while the vehicle is in a mobilized operating state.

### SUMMARY

According to an embodiment of the invention, there is provided a method of using the communication system to install a vehicle update in a vehicle system module (VSM) onboard a vehicle while enabling the vehicle to remain in a mobilized state during the installation of the vehicle update. The method includes the steps of receiving a vehicle update for a target VSM in the vehicle while the vehicle is in the mobilized state; performing a hand-off operation procedure between a proxy device and the target VSM so that the proxy device is granted permission to execute vehicle operating instructions as if the proxy device is the target VSM; thereafter, installing the vehicle update at the target VSM; and continuing operation of the vehicle in the mobilized state using the proxy device instead of the target VSM during the installing step.

According to another embodiment of the invention, there is provided a computer program product that includes a non-transitory computer-readable medium for a mobile device, that includes computer program instructions that enable the mobile device to execute temporarily an updated set of operating instructions on behalf of a vehicle system module (VSM) in a vehicle while the updated set of operating instructions is being installed therein, thereby enabling the vehicle to remain in a mobilized state during the installation. The computer program product includes: instructions for receiving the updated set of operating instructions at the mobile device from a remote server; instructions for communicating with the vehicle via a gateway module therein in response to the receiving step; and instructions for performing a hand-off operation procedure in response to receiving a readiness message from the gateway module, wherein, during the hand-off operation procedure, the mobile device executes the updated set of operating instructions for the vehicle via the gateway module so that the vehicle may continue operations while the gateway module installs the updated set of operating instructions in the VSM.

### BRIEF DESCRIPTION OF THE DRAWINGS

One or more embodiments of the invention will hereinafter be described in conjunction with the appended drawings, wherein like designations denote like elements, and wherein:

FIG. 1 is a schematic diagram depicting an embodiment of a communications system that is capable of utilizing the method disclosed herein; and

FIG. 2 is a flow diagram depicting a method of installing a vehicle update in a vehicle system module onboard a vehicle.

### DETAILED DESCRIPTION OF THE ILLUSTRATED EMBODIMENT(S)

A communication system is described below that is capable of installing vehicle updates (or vehicle system updates) in various vehicle system modules (VSMs) in the vehicle while the vehicle is in a mobilized state—i.e., in a state that the vehicle can be driven and operated normally. Conventionally, the vehicle temporarily is immobilized (disabled) or at least partially disabled during this process. For example, during immobilization, it is common to require the vehicle transmission to be placed into PARK during installation of a vehicle update—thus, the vehicle cannot be driven (e.g., operated in DRIVE, REVERSE, etc.). Thus, the immobilized state may include electronically and/or mechanically inhibiting or limiting operation of some vehicle subsystems—e.g., the engine control module (ECM), a fuel pump or fuel system, or the like may be at least partially inoperative. In the present system, the vehicle is not required to be parked, but can be driven normally, operated in reverse, and the like during installation of the vehicle update. Further, during installation of the update, fuel is not governed, nor are electrical or mechanical vehicle features actuated to limit or inhibit operation because of the ongoing vehicle update installation. To accomplish this, one of the VSMs, a gateway or gateway communication module, communicates with a proxy device to carry out the normal operations of the particular VSM being updated. One example of a proxy device is a Smart phone having special vehicle application software installed thereon. Thus, for example, the gateway module may coordinate a hand-off operation procedure wherein the Smart phone takes over functions and operations of a target VSM (e.g., a VSM which is receiving a software or firmware update). While the Smart phone temporarily behaves as the target VSM, the vehicle update is installed at the target VSM. During this period of time, the vehicle can be operated normally. For example, even if the target VSM is the engine control module, the Smart phone may execute instructions of an engine control module so that the vehicle is not required to be immobilized. Once the target VSM is updated, a reverse hand-off operation procedure may occur, wherein the target VSM resumes control of functions and operations (and of course, at that time, the Smart phone ceases to execute such instructions).

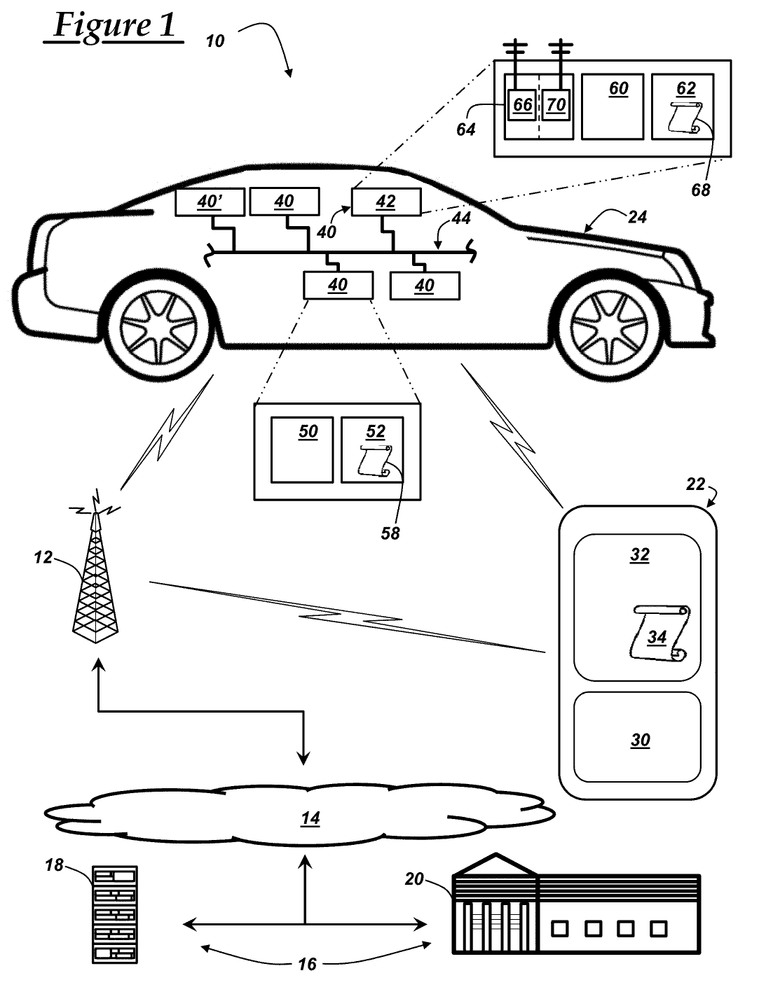

With reference to FIG. 1, there is shown an operating environment that comprises a mobile vehicle communications system 10 and that can be used to implement the method disclosed herein. Communications system 10 generally includes: one or more wireless carrier systems 12; a land communications network 14; a backend system 16 that includes at least one of a remote server 18 or a data service center 20; a mobile device 22; and a vehicle 24. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Wireless carrier system 12 is preferably a cellular telephone system that in some implementations includes a plurality of cell towers (only is one shown), one or more mobile switching centers (MSCs) (not shown), as well as any other networking components required to connect wireless carrier system 12 with land network 14. Each cell tower includes sending and receiving antennas and a base station, with the base stations from different cell towers being connected to the MSC either directly or via intermediary equipment such as a base station controller. Cellular system 12 can implement any suitable communications technology, including for example, analog technologies such as AMPS, or the newer digital technologies such as GSM/GPRS, CDMA (e.g., CDMA2000), or LTE. As will be appreciated by those skilled in the art, various cell tower/base station/MSC arrangements are possible and could be used with wireless system 12. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Land network 14 may be a conventional land-based telecommunications network that is connected to one or more landline telephones and connects wireless carrier system 12 to backend system 16. For example, land network 14 may include a public switched telephone network (PSTN) such as that used to provide hardwired telephony, packet-switched data communications, and the Internet infrastructure. One or more segments of land network 14 could be implemented through the use of a standard wired network, a fiber or other optical network, a cable network, power lines, other wireless networks such as wireless local area networks (WLANs), or networks providing broadband wireless access (BWA), or any combination thereof. Furthermore, data service center 20 need not be connected via land network 14, but could include wireless telephony equipment so that it can communicate directly with a wireless network, such as wireless carrier system 12.

Remote server 18 of system 16 can provide vehicles with a number of different system back-end functions and can be one of a number of computers accessible via a private or public network such as the Internet. Each such server 18 can be used for one or more purposes, such as a web server accessible via land network 14 and/or wireless carrier 12. Other such accessible servers 18 can be, for example: a service center computer where diagnostic information and other vehicle data can be uploaded from the vehicle 24; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 24 or data service center 20, or both. Remote server 18 can also be used for providing Internet connectivity such as DNS services or as a network address server that uses DHCP or other suitable protocol to assign an IP address to the vehicle 24. In one embodiment, the remote server 18 is part of or associated with the data service center 20; however, this is not required.

Data service center 20 of system 16 also is designed to provide vehicles with a number of different system back-end functions and generally includes one or more switches, servers, databases, live advisors, as well as an automated voice response system (VRS), all of which are known in the art. These various data service center components are preferably coupled to one another via a wired or wireless local area network. Switch, which can be a private branch exchange (PBX) switch, routes incoming signals so that voice transmissions are usually sent to either the live adviser by regular phone or to the automated voice response system using VoIP. The live advisor phone can also use VoIP; VoIP and other data communication through the switch may be implemented via a modem connected between the switch and network. Data transmissions are passed via the modem to server and/or database. Database can store account information such as subscriber authentication information, vehicle identifiers, profile records, behavioral patterns, and other pertinent subscriber information. Data transmissions may also be conducted by wireless systems, such as 802.11x, GPRS, and the like. Although one embodiment has been described as it would be used in conjunction with a manned data service center 20 using a live advisor, it will be appreciated that the data service center can instead utilize VRS as an automated advisor or, a combination of VRS and a live advisor can be used.

In at least one embodiment, the server 18, the data service center 20, or both may store and/or transmit vehicle updates or vehicle system module (VSM) updates to a number of vehicles like vehicle 24 via the land network 14, via the cellular network 12, via other suitable communication infrastructure(s) (e.g., such as a wireless local area network or WLAN), or via any combination thereof. These vehicle updates may replace, modify, or over-write existing vehicle hardware module instructions (e.g., a hardware module operating system (OS), software instructions, firmware instructions, or the like). For example, the backend system 16 may determine an appropriate vehicle update by storing a vehicle identifier for all vehicles it services (e.g., a vehicle identification number (VIN) or the VIN@Onstar.com), as well as identifiers for various hardware and software components in each vehicle. Thus, for example, for vehicle 24, the backend system 16 may store multiple hardware module identifiers (e.g., model and serial numbers) and software version identifiers (e.g., of the last-installed or last-updated software version associated with each of the hardware modules). As will be explained in greater detail below, the transmission of the vehicle updates may be carried out while the vehicle is in an operational or mobilized state—i.e., as used herein, a mobilized state includes a state where vehicle 24 is capable of being placed in DRIVE or REVERSE and driven normally. Thus, the mobilized state does not require that the vehicle 24 actually be in DRIVE or driving (e.g., moving); it merely requires that the vehicle 24 is capable of being driven forwardly, in reverse, etc. Thus, vehicle 24 is not immobilized by inhibiting/limiting or partially inhibiting/limiting vehicle functionality or operability, as it would be in conventional vehicle update solutions (as described above).

Turning now to the mobile device 22 (FIG. 1), as will be described in greater detail below, mobile device 22 may serve as a proxy or substitute computer hardware for carrying out at least some vehicle functions during the installation of a vehicle update in one of the vehicle hardware modules. Mobile device 22 may be any suitable portable electronic device. The device 22 may be capable of cellular voice and/or data calls across a wide geographic area where transmissions are facilitated by the wireless carrier system 12. For example, mobile device 22 may be configured to provide cellular services according to a subscription agreement with a third-party facility such as a wireless service provider (WSP). In some embodiments, mobile device 22 may be tetherable to the vehicle 24 by wire, may be wirelessly couplable to vehicle 24 via a short-range wireless communication (SRWC) protocol (e.g., such as Wi-Fi Direct, Bluetooth, Bluetooth Low Energy (BLE), Near-Field Communication (NFC), or the like), or both.

Mobile device 22 may include a user interface (e.g., for input/output (I/O)) (not shown) coupled to a processor 30 which is configured to execute an operating system (OS) stored on device memory 32 (e.g., on a non-transitory computer readable medium of the device). The processor 30 further may execute one or more computer program products stored in device memory 32 as well—e.g., the computer program product(s) may be any suitable program code, collection of instructions, etc., and may be embodied as executable application software 34 that may or may not require user interaction (I/O). Using such application(s) 34, a vehicle user may communicate with vehicle 24, the backend system 16, or both (e.g., via cellular communication, SRWC, the land network 14, or a combination thereof). In one embodiment, at least one software application 34 may enable the user to operate the vehicle 24 in a mobilized state while the vehicle 24 is installing a vehicle update received from the backend system 16 at a vehicle hardware module. For example, as described more below, while the vehicle update is being installed in the hardware module, the mobile device 22, using application 34, may behave as a proxy by carrying out functions and operations of said hardware module—e.g., so that the vehicle 24 can be driven if desired and otherwise operated normally. For example, operations carried out by the vehicle 24 and mobile device 22 may appear to a user to be typical—and thus, in one embodiment, the user may be unaware of the ongoing vehicle update process. Thus, according to one embodiment, application 34 may perform at least some of the method steps described herein—and may perform those steps automatically.

Some non-limiting examples of the mobile device 22 include a Smart phone, a cellular telephone, a personal digital assistant (PDA), a personal laptop computer or tablet computer having two-way communication capabilities, a netbook computer, a notebook computer, or any suitable combinations thereof. Device 22 may be used inside or outside of vehicle 24 by a vehicle user who may be a vehicle driver or passenger. It should be appreciated that the user does not need to have ownership of the mobile device 22 or the vehicle 24 (e.g., the vehicle user may be an owner or a licensee of the mobile device, the vehicle, or both).

Turning to vehicle 24 (FIG. 1), the vehicle is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Vehicle 24 may include a number of electrical components, including but not limited to one or more vehicle system or hardware modules (VSMs) 40. One of the VSMs 40 may be a gateway module or gateway communication module 42, and in at least one embodiment, the VSMs 40 and gateway module 42 may be coupled to one or more network connections 44 (e.g., a bus, as will be described below).

The vehicle system modules (VSMs) 40 can be any modular hardware device designed to execute or perform categorical vehicle functions or tasks, or functions or tasks in a particular zone or area of the vehicle 12 (e.g., a front region, a rear region, a side region, etc.). Each VSM 40 may be coupled to various local hardware components, may have suitable control electronics (e.g., including a local processor 50, local memory 52, instructions or code 58 stored on memory 52 that is executable by the processor 50, etc.). Further, VSMs 40 may have any suitable electrical interface for communicating over network connection(s) 44.

Non-limiting examples of other VSMs 40 include a GPS module, an engine control module (ECM), a body control module (BCM), a powertrain control module (PCM), and the like, all of which are known in the art. In some implementations, a GPS module may determine a vehicle position that is used for providing navigation and other position-related services; further, such information may be provided to users of vehicle 24. The ECM automatically may control various aspects of engine operation such as fuel ignition and ignition timing. In addition, the ECM could be equipped with on-board diagnostic features that provide myriad real-time data, such as that received from various sensors including vehicle emissions sensors, and may provide a standardized series of diagnostic trouble codes (DTCs) that allow a technician to rapidly identify and remedy malfunctions within the vehicle 24. In some implementations, the BCM may govern various electrical components located throughout the vehicle 24, like the vehicle's power door locks and headlights, which may be automated, user-actuated, or a combination thereof. And the PCM could be configured to regulate operation of one or more components of the vehicle powertrain. These of course are merely examples of vehicle system modules 40; other embodiments exist.

Gateway module 42 may be an electronic module adapted to be an intermediary or portal-type device between the VSMs 40 and extra- or non-vehicular devices, such as mobile device 22. According to at least one embodiment, the gateway module 42 may be configured to communicate via short range wireless communication (SRWC) and may include a processor 60, memory 62, and a communication circuit 64 having one or more SRWC chipsets 66.

Processor 60 can be any type of device capable of processing electronic instructions, non-limiting examples including a microprocessor, microcontroller, host processor, controller, vehicle communication processor, and an application specific integrated circuit (ASIC). It may be a dedicated processor used only for gateway module 42, or it may be shared with other vehicle systems. Processor 60 executes digitally-stored instructions 68, which may be stored in memory 62, which enable the gateway module 42 to perform one or more vehicle communication functions—e.g., including communicating concurrently at times with mobile device 22, one or more VSMs 40, and in some implementations, backend system 16.

Memory 62 may include any non-transitory computer usable or readable medium, which include one or more storage devices or articles. Exemplary non-transitory computer usable storage devices include conventional computer system RAM (random access memory), ROM (read only memory), EPROM (erasable, programmable ROM), EEPROM (electrically erasable, programmable ROM), and magnetic or optical disks or tapes. As discussed above, memory 62 may store one or more computer program products which may be embodied as software and/or firmware. For example, memory 62 may store instructions 68 which enable the gateway module 42 to facilitate at least a portion of the method described herein.

In some implementations, the gateway module 42 may be part of a vehicle head unit (e.g., infotainment unit) and may have a user interface (e.g., having control knobs, buttons, display, etc.)—e.g., being part of the center stack module; however, this is not required. Further, in at least one embodiment, the gateway module 40 is configured to perform telematics functions—e.g., including but not limited to communicating with other cellular devices via a voice call, a data call, or both. Thus, in at least one embodiment, the communication circuit 64 described above includes one or more cellular chipsets 70 so that gateway module 42 may support cellular connectivity according to one or more cellular protocols—e.g., including but not limited to GSM/GPRS, CDMA (e.g., CDMA2000), and LTE. According to one embodiment, as will be described in the method below, gateway module 42 establishes communication with backend system 16, receives one or more vehicle updates, and provides the vehicle updates to the appropriate vehicle system module(s) 40, while maintaining communication with mobile device 22 via a wired or wireless connection.

Network connections 44 include any wired intra-vehicle communications system for connecting or coupling gateway module 42 and other VSMs 40 to one another, as well as coupling module 42 and VSMs 40 to other electronic devices. According to one embodiment, the network connection 44 comprises a data bus (e.g., a communication bus, entertainment bus, etc.). Non-limiting examples of suitable network connections include a controller area network (CAN), a media oriented system transfer (MOST), a local interconnection network (LIN), a local area network (LAN), and other appropriate connections such as Ethernet, Audio-Visual Bridging (AVB), or others that conform with known ISO, SAE and IEEE standards and specifications, to name but a few.

In general, when user/customer acquires vehicle 24, the VSMs 40 have instructions 58 stored and installed thereon—e.g., which command the respective VSM to operate according to the desired functions thereof. For example, instructions of the ECM command the ECM to control engine functions; instructions of the PCM command the PCM to control powertrain functions; etc. After the VSMs 40 of the vehicle 24 are initially configured, the vehicle manufacturer may develop vehicle updates—i.e., improvements or changes to the existing instructions which may include new instructions, new functionalities, etc. Conventionally, installation of these vehicle update(s) in VSMs 40 are performed by a service technician at an authorized vehicle service facility or sometimes by the user (e.g., while the vehicle is parked at the user's residence or the like). Regardless, conventional installation requires the vehicle 24 to be in an immobilized state; e.g., for operability or safety reasons. In fact, the service technician or user is often required to respond affirmatively to a prompt indicating that the vehicle will be immobilized during a vehicle update installation process—such immobilization being a safety feature. Consider for example installing a vehicle update to the ECM which controls numerous engine functionalities. During the installation, the updated instructions or code that corresponds to specific vehicle functions may be changed, replaced, or even overwritten; thus, such functionalities are unavailable for execution and consequently vehicle operation. Thus conventionally, the vehicle 24 would be immobilized during this update process. This is merely one example; many other VSM examples exist, as will be appreciated by skilled artisans.

The method described below obviates the undesirable aspects of conventional vehicle update installation processes. The described method enables the vehicle user to operate the vehicle in a mobilized state during the installation process by having a proxy device such as mobile device 22 carry out the functions or tasks of a target VSM 40—i.e., a VSM which is installing the vehicle update.

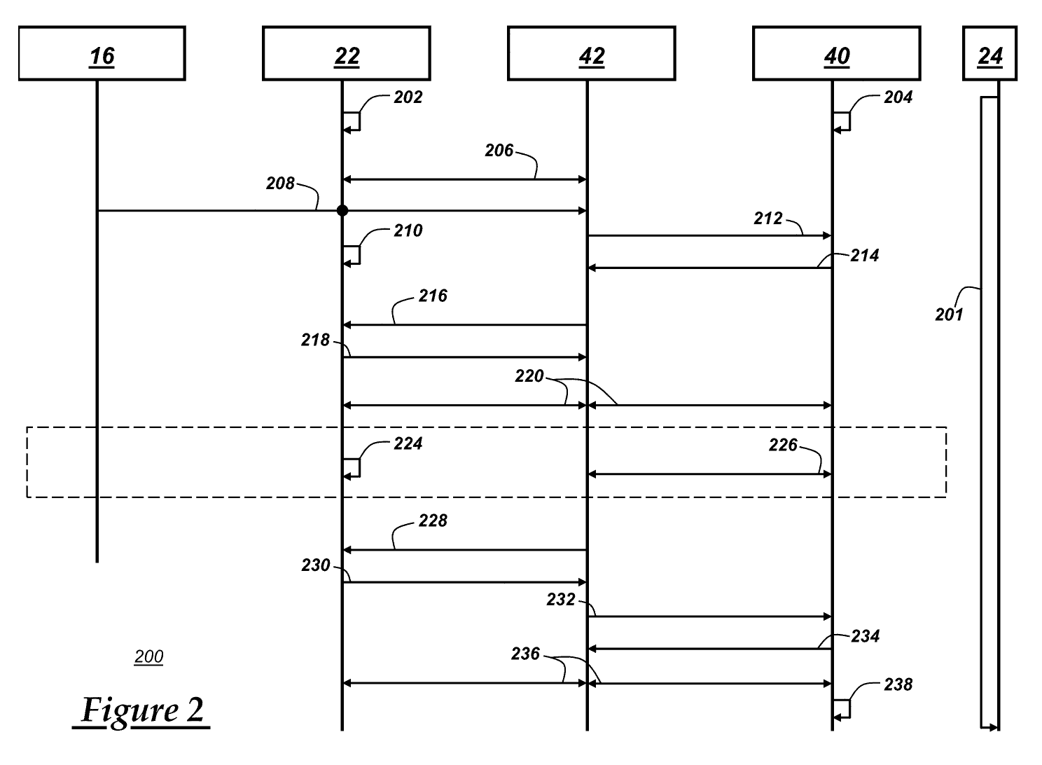

Turning now to FIG. 2, there is shown a flow diagram depicting a method of installing a vehicle update in a VSM 40 onboard vehicle 24. The method begins with step 201 which represents the vehicle 24 being in a mobilized state. For example, step 201 may include a transmission of vehicle 24 being in DRIVE and the vehicle being operated in DRIVE—or at least capable of shifting to DRIVE and being driven. It will be appreciated that step 201 may occur concurrently with all other steps 202-232. Thus, step 201 represents that the installation of the vehicle update can occur without interruption to normal vehicle operations; further, in general, the installation may be transparent to the vehicle user. For example, while in some embodiments, it may be desirable to notify the user or to have the user respond to a prompt on mobile device 22 to initiate the installation procedure, the subsequent hand-off operation procedure and reverse hand-off operation procedure described below may be automated—i.e., they may not require user participation.

Step 202 occurs concurrently with step 201 (or in some embodiments occurs before or after step 201). In this step, application software 34 may be installed in memory 32 of mobile device 22. Among other things, the application software 34 may be adapted to: receive a vehicle update from the backend system 16; using the received update, install the update in memory 32; and using the processor 30, communicate with gateway module 42 while concurrently executing instructions associated with the vehicle update to carry out vehicle functions, tasks, operations, or the like associated with one of the VSMs 40—i.e., a target VSM. Thus, mobile device 22 using software 34 operates as a special-purpose computer adapted to perform particular functions that include performing a hand-off operation procedure and a reverse hand-off operation procedure, as described more below.

While the vehicle 24 is capable of being driven or operated normally (step 201), the processor 50 of target VSM 40 executes a first set of instructions 58 stored in memory 52 prior to any installation of a vehicle update (step 204). Thus, the first set of instructions 58 include any instructions previously stored in memory 52 (e.g., original instructions installed by the vehicle manufacturer, or any previously updated instructions installed according to any previous vehicle update procedure). Of course, the nature of the first set of instructions will vary depending on the function and operation of the particular VSM 40; i.e., instructions which operate a BCM will differ from those of an ECM, etc.

In step 206, a short-range wireless communication (SRWC) link between the gateway module 42 and the mobile device 22 may be established. The SRWC link may be according to any suitable protocol; non-limiting examples include Bluetooth, BLE, Wi-Fi Direct, and the like. SRWC links and communication/connectivity using such links are generally known and will not be described further here.

In step 208, the mobile device receives a second set of instructions from the backend system 16 (e.g., from the remote server 18 or the data service center 20)—i.e., the second set of instructions may be an update to the first set of instructions 58 being currently used by the target VSM 40. The mobile device 22 may receive these instructions in response to performing step 202 (installing software application 34) and a known relationship between the user of the vehicle 24 and the user of the mobile device 22 (i.e., that the mobile device 22 belongs to or is otherwise associated with an authorized user of the vehicle 24 and mobile device 22, and the user has granted permission to carry out method 200 previously, or, e.g., does so during the method). For example, instructions may be sent to mobile device 22 in step 208 as a result of the mobile device being previously authorized to participate in procedures such as the hand-off operation procedure and reverse hand-off operation procedure, which are described below.

Step 208 further may include transmitting or otherwise providing the received second set of instructions from the mobile device 22 to the gateway module 42. This may occur via the SRWC link—or any other suitable link (e.g., wired, cellular, etc.). Other implementations of this aspect of step 208 are also possible—e.g., the gateway module 42 could receive the second set of instructions directly from the remote backend 16 or via another intermediary device (e.g., other than mobile device 22) instead. It should be appreciated that the second set of instructions may be communicated from the backend system 16 ultimately to a variety of vehicles having the same target VSM 40 operating using the same first set of instructions 58 (e.g., like vehicle 24).

Following step 208, the mobile device 22 may install the second set of instructions—e.g., or may update application software 34 to include the second set of instructions (step 210). This may or may not require user interaction. Following step 210, the mobile device 22 may be equipped to serve as a proxy device for the target device during the hand-off operation procedure described below (e.g., executing the second set of instructions). Of course, in other embodiments, the mobile device 22 could serve as the proxy device using the first set of instructions instead (i.e., while the second set of instructions is installed on target VSM 40). (For example, mobile device 22 previously may have received the first set of instructions instead.) In at least one embodiment, it is preferred that step 210 includes the installation of the second set of instructions at mobile device 22—e.g., thus during the hand-off operation procedure discussed below, the vehicle 24 acquires the ability to utilize updated or newer instructions (by proxy) sooner than it would if instead mobile device 22 had only installed the first set of instructions during the installation step 210.

In step 212, gateway module 42 may transmit a readiness message to the target VSM 40 (e.g., via bus 44). The readiness message informs the target VSM 40 that the gateway module 42 has received a vehicle update for the target VSM; further, the readiness message may request that the target VSM 40 prepare to execute hand-off operation procedures with the proxy device (e.g., the mobile device 22). And, when appropriately ready, in step 214, the target VSM 40 may acknowledge its readiness.

Step 216 illustrates that the gateway module 42 may send a similar readiness message to mobile device 22 (e.g., via the SRWC link). This readiness message informs the mobile device that the gateway module 42 and the target VSM 40 are prepared to execute hand-off operation procedures. In response, in some embodiments, the mobile device 22 may notify and/or prompt the user thereof to affirm that the mobile device may be used to carry out the procedures. However, this is optional. When mobile device 22 is appropriately ready (and/or when a user has authorized the procedures via the mobile device 22), mobile device 22 may acknowledge its readiness (e.g., via the SRWC link) in step 218.

In step 220, a hand-off operation procedure is initiated. According to one embodiment, this initiation is performed by the gateway module 42—e.g., because the gateway module is in a unique position of knowing the readiness of both the target VSM 40 and the mobile device 22, which might not otherwise be in communication with one another. Initiation includes coordinating the mobile device taking over the execution of operating instructions normally performed by target VSM 40 when the target VSM ceases to execute such operating instructions. For example, when the target VSM 40 ceases to execute the first set of instructions, the mobile device 22 then may begin to execute the first or second set of instructions (step 224). To initiate the hand-off operation procedure, the gateway module 42 may transmit a synchronized trigger signal to both the devices 22, 40 so that the hand-off is seamless. In some implementations, previously queued tasks or functions in the target VSM 40 may be transferred to the mobile device 22 (via the gateway module 42)—e.g., so that the mobile device 22 may carry out the executions thereof.

Once initiated, in step 224 the mobile device 22 executes all suitable functions, tasks, operations, etc. according to the instructions in application software 34 (e.g., the second set of instructions). During this period, the gateway module 42 functions as a bi-directional conduit or pass-through device enabling mobile device connectivity to the network connection 44 (e.g., the bus) so that the mobile device 22 may send and receive data—e.g., send and receive messages via the bus.

Once step 224 is occurring, the gateway module 42 may participate in the installation of the vehicle update at target VSM 40 (step 226)—i.e., steps 224 and 226 occur at least partially concurrently. In at least one embodiment, the gateway module 42 installs the second set of instructions (the vehicle update) on memory 52 of target VSM 40—e.g., using network connection 44. This second set of instructions may modify, replace, or over-write the first set of instructions 58 and is commonly referred to as flashing (or reflashing) the target VSM 40—i.e., updating the respective operating system thereof. In some embodiments, the gateway module 42 reflashes the target VSM 40. And in other embodiments, the vehicle update may be provided from the gateway module 42 to the target VSM 40, and the target VSM 40 may perform the reflash itself (i.e., the gateway module 42 does not participate in the reflash). Step 226 continues until the installation, any rebooting or restarting (if necessary), etc. is completed.

In step 228, gateway module 42 may transmit a readiness message to the mobile device 22—e.g., indicating that vehicle update has been installed in the target VSM (i.e., that the installation is complete). Further, this readiness message may request that the mobile device 22 prepare to execute a reverse hand-off operation procedure with the target VSM 40 (via gateway module 42). In response, in some embodiments, the mobile device 22 may prompt or notify the user that the mobile device will stop carrying out the aforementioned procedures. However, this is also optional. Reverse hand-off operation procedures include coordinating the target VSM's take-over of the execution of operating instructions (e.g., the second set of instructions) from the proxy device 22 when the proxy device ceases to execute those instructions on its behalf. When appropriately ready, in step 230, the mobile device 22 may acknowledge its readiness.

Step 232 illustrates that the gateway module 42 may send a similar readiness message to the target VSM 40. This readiness message may inform the target VSM that the gateway module 42 and mobile device 22 are prepared to execute the reverse hand-off operation procedures. When the target VSM 40 is appropriately ready, target VSM 40 may acknowledge its readiness in step 234.

In step 236, the reverse hand-off operation procedure is executed. Like the hand-off operation discussed above, in at least one embodiment, this is performed by the gateway module 42—e.g., because the gateway module is in a unique position of knowing the readiness of both the target VSM 40 and the mobile device 22, which might not otherwise be in communication with one another. Hand-off operation procedures in reverse may be similar to those discussed above (in step 220), except that the mobile device 22 ceases execution of VSM operation instructions and the target VSM 40 resumes execution of operating instructions (step 238)—except now as a result of the vehicle update, the target VSM 40 executes modified, replaced, or over-written instructions—i.e., the second set of instructions.

As previously discussed, during any of steps 202-238, the vehicle 24 may be placed in DRIVE, REVERSE, etc. and driven or otherwise operated normally. In at least one embodiment, steps 204-238 occur automatically at the vehicle 24 without notification to the user and without user interaction (e.g., the link in step 206 may be automated based on previous identification, a previous pairing or bonding, or the like). Thus, the vehicle user may be driving or en route to a destination and method steps 204-238 may be carried out without the user knowing they have occurred.

In addition, method 200 may be repeated with one or more different VSMs 40. Or for example at a later time, the same target VSM may be reflashed again (e.g., with a third set of instructions, etc.). For each reflash, the backend system 16 may record/store identifiers associated with the installed code or software version so that the backend system may appropriately provide new vehicle updates as they become available.

In at least one embodiment, the target VSM 40 includes electronic hardware required for vehicle mobility—i.e., without operation of the target VSM (or proxy operation on behalf thereof), the vehicle cannot be driven or operated. For example, the target VSM 40 could be an engine control module (ECM), a powertrain control module (PCM), or a body control module (BCM). Other target VSMs 40 might include a sensing and diagnostic module (SDM), an electronic climate control (ECC) device, an instrument panel cluster (IPC), an adaptive cruise control (ACC) device, an advanced driver assistance system or ADAS map module (AMM), an external object camera module (EOCM) for imaging objects outside of the vehicle (e.g., the EOCM may be used with one or more other modules or devices), a transmission control module (TCM), a passive entry passive start device (PEPS), a universal park assist (UPA) device, etc.

Other embodiments also exist. For example, in method 200, mobile device 22 acted as a proxy device; however, this is not required. For example, the proxy device could be any other suitable electronic device capable of interfacing with the network connection 44, wherein the communication speed is sufficiently fast to avoid undesirable latencies. For example, according to one embodiment, VSM 40′ (FIG. 1) could act as the proxy device instead of mobile device 22. In this embodiment, the gateway module 42 could receive the vehicle update from mobile device 22, directly from the backend system 16, etc., and then the hand-off (and reverse hand-off) operation procedures may be carried out using VSM 40′. In at least one aspect, using mobile device 22 instead of using VSM 40′ as the proxy device is preferred as implementing the VSM 40′ in such a manner can increase the size, weight, and cost of VSM 40′. For example, VSM 40′ may require additional or faster processors, additional memory, etc. to carry out this embodiment.

In another embodiment, the gateway module 42 may act as the proxy device in a manner similar to VSM 40′. And still other embodiments are also possible.

Thus, there has been described a communication system adapted to facilitate updating operating instructions for vehicle electronics using a proxy device, and more particularly, a method of installing a vehicle update in a target vehicle system module (VSM) onboard a vehicle while enabling the vehicle to remain in a mobilized state during the installation of the vehicle update. The proxy device can receive, store, and execute operating instructions for the target VSM allowing the target VSM to install the vehicle update. Once the vehicle update is installed, a reversion of control occurs wherein the target VSM resumes executing operating instructions and the proxy device ceases such execution on its behalf—e.g., however now, the target VSM executes updated (e.g., replaced, revised, over-written, etc.) operating instructions as a result of the installation. While the method is carried out, the vehicle remained in a mobilized state—e.g. the vehicle may be driven or otherwise operated normally—e.g., instead of requiring temporary vehicle immobilization which requires time and can result in user frustration.

It is to be understood that the foregoing is a description of one or more embodiments of the invention. The invention is not limited to the particular embodiment(s) disclosed herein, but rather is defined solely by the claims below.

Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of installing a vehicle update in a vehicle system module (VSM) onboard a vehicle while enabling the vehicle to remain in a mobilized state during the installation of the vehicle update, the method comprising the steps of:
receiving a vehicle update for a target VSM in the vehicle while the vehicle is in the mobilized state;
performing a hand-off operation procedure between a proxy device and the target VSM so that the proxy device is granted permission to execute vehicle operating instructions as if the proxy device is the target VSM; thereafter,
installing the vehicle update at the target VSM; and
continuing operation of the vehicle in the mobilized state using the proxy device instead of the target VSM during the installing step.

2. The method of claim 1, wherein a gateway module in the vehicle receives the vehicle update from the proxy device, wherein the gateway module installs the vehicle update in the target VSM.

3. The method of claim 1, wherein the gateway module is coupled to the target VSM via a vehicle bus, wherein the gateway module is coupled to the proxy device via a short range wireless communication (SRWC) link.

4. The method of claim 1, wherein the proxy device is a mobile device having application software installed thereon adapted to execute the vehicle operating instructions of the target VSM.

5. The method of claim 1, wherein the proxy device is a gateway module in the vehicle or another VSM in the vehicle.

6. The method of claim 1, further comprising:
receiving the vehicle update at a mobile device;
prior to the receiving the vehicle update for the target VSM, installing the vehicle update at the mobile device so that the mobile device may execute the vehicle operating instructions associated with the continuing vehicle operations; and
providing the vehicle update from the mobile device to a gateway module having a communication link with the target VSM.

7. The method of claim 1, further comprising:
in response to the installing step, performing a reverse hand-off operation procedure between the proxy device and the target VSM so that the target VSM is granted permission to begin executing vehicle operating instructions again in the vehicle, wherein the target VSM executes a different set of operating instructions than it did prior to the installation.

8. The method of claim 7, wherein the different set of operating instructions are identical to the operating instructions executed by the proxy device while the vehicle update was being installed in the target VSM.

9. The method of claim 1, wherein the target VSM is one of an engine control module (ECM), a powertrain control module (PCM), or a body control module (BCM).

10. A computer program product, comprising a non-transitory computer-readable medium for a mobile device, comprising computer program instructions that enable the mobile device to execute temporarily an updated set of operating instructions on behalf of a vehicle system module (VSM) in a vehicle while the updated set of operating instructions is being installed therein, thereby enabling the vehicle to remain in a mobilized state during the installation, said computer program product comprising:
instructions for receiving the updated set of operating instructions at the mobile device from a remote server;
instructions for communicating with the vehicle via a gateway module therein in response to the receiving step; and
instructions for performing a hand-off operation procedure in response to receiving a readiness message from the gateway module, wherein, during the hand-off operation procedure, the mobile device executes the updated set of operating instructions for the vehicle via the gateway module so that the vehicle may continue operations while the gateway module installs the updated set of operating instructions in the VSM.

11. The computer program product of claim 10, further comprising:
instructions for performing a reverse hand-off operation procedure in response to receiving a completion message from the gateway module indicating that the installation is complete, wherein, during the reverse hand-off operation procedure, the mobile device ceases to execute the updated set of operating instructions for the vehicle so that the VSM may begin to execute the updated set of operating instructions.

12. The computer program product of claim 10, further comprising instructions for communicating with the vehicle via the gateway module via a short range wireless communication (SRWC) link.

13. The computer program product of claim 12, wherein communications associated with the hand-off operation procedure occur via the SRWC link between the mobile device and the gateway module, wherein the gateway module installs the updated set of operating instructions in the VSM via a vehicle bus.

14. The computer program product of claim 10, wherein the instructions for performing a hand-off operation procedure are executed while the gateway module installs the updated set of operating instructions in one of an engine control module (ECM), a powertrain control module (PCM), or body control module (BCM).

15. The computer program product of claim 10, wherein the instructions for performing the hand-off operation procedure are automated.
